(19) United States
(12) Patent Application Publication
(10) Pub. No.: US 2025/0037927 A1
(43) Pub. Date: Jan. 30, 2025

(54) COIL COMPONENT

(71) Applicant: SAMSUNG ELECTRO-MECHANICS CO., LTD., Suwon-si (KR)

(72) Inventors: Dong Hwan LEE, Suwon-si (KR); Dong Jin LEE, Suwon-si (KR); Tae Hyun KIM, Suwon-si (KR); Soon Kwang KWON, Suwon-si (KR)

(73) Assignee: SAMSUNG ELECTRO-MECHANICS CO., LTD., Suwon-si (KR)

(21) Appl. No.: 18/634,160

(22) Filed: Apr. 12, 2024

(30) Foreign Application Priority Data
Jul. 27, 2023 (KR) 10-2023-0097947

(51) Int. Cl. H01F 27/28; H01F 5/02; H01F 5/04; H01F 27/29

(52) U.S. Cl. CPC H01F 27/2828; H01F 27/292; H01F 27/306

(57) ABSTRACT

According to an aspect of the present disclosure, a coil component includes a body including a first surface and a second surface opposing each other in a first direction; a coil disposed in the body and including a coil pattern and a lead-out portion extending from the coil pattern, wherein the coil pattern is divided into a first region in which the lead-out portion is disposed, and a second region in which the lead-out portion is not disposed with respect to a central line perpendicular to the first direction and passing through a center of the coil pattern, and wherein an outermost turn of the second region includes a plurality of corner portions, and a first connection portion connecting the plurality of corner portions, and a length of the first connection portion is shorter than a length of each of the corner portions.

### CROSS-REFERENCE TO RELATED APPLICATION(S)

This application claims the benefit of priority to Korean Patent Application No. 10-2023-0097947 filed on Jul. 27, 2023 in the Korean Intellectual Property Office, the disclosure of which is incorporated herein by reference in its entirety.

### TECHNICAL FIELD

The present disclosure relates to a coil component.

### BACKGROUND

An inductor, a coil component, may be a representative passive electronic component used in an electronic device along with a resistor and a capacitor.

As an electronic device has been designed to have high-performance and a reduced size, the number of electronic components used in an electronic device has increased and a size thereof has been reduced.

In a miniaturized coil component, a self-resonant frequency (SRF) may decrease as parasitic capacitance (Cp) is formed between an external electrode and a coil. When a distance between the external electrode and the coil increases to increase SRF, a central core area may decrease and saturation current (Isat) properties may deteriorate.

Accordingly, there has been demand for a coil structure which may maintain the central core area while a distance between the external electrode and the coil increases.

### SUMMARY

An aspect of the present disclosure is to increase self-resonant frequency (SRF) by increasing a distance between an external electrode and a coil.

Another aspect of the present disclosure is to prevent deterioration of saturation current (Isat) properties by increasing a distance between an external electrode and a coil and maintaining an area of a central core or reducing the area to a minimum.

According to an aspect of the present disclosure, a coil component includes a body including a first surface and a second surface opposing each other in a first direction, and a third surface and a fourth surface opposing each other in a second direction perpendicular to the first direction; a coil disposed in the body and including a coil pattern having at least one turn and a lead-out portion extending from an outer end of the coil pattern to the first surface or the second surface; and an external electrode disposed on the body and connected to the coil, wherein the coil pattern is divided into a first region in which the lead-out portion is disposed, and a second region in which the lead-out portion is not disposed with respect to a central line perpendicular to the first direction and passing through a center of the coil pattern on a cross-section perpendicular to a winding axis of the coil pattern, and wherein an outermost turn of the second region includes a plurality of corner portions having a quadrant arc shape, and a first connection portion having a linear shape connecting the plurality of corner portions to each other, and a length of the first connection portion is shorter than a length of each of the corner portions.

### BRIEF DESCRIPTION OF DRAWINGS

The above and other aspects, features, and advantages of the present disclosure will be more clearly understood from the following detailed description, taken in conjunction with the accompanying lead-outs, in which:

FIG. 1 is a perspective diagram illustrating a coil component according to a first embodiment of the present disclosure;

FIG. 2 is a plan diagram and an enlarged diagram in FIG. 1;

FIG. 3 is a diagram illustrating an internal angle and a quadrant region between an extended line of a boundary between a corner portion and a first connection portion and an extended line of a boundary between a corner portion and a second connection portion in a plan diagram in FIG. 1;

FIG. 4 is a cross-sectional diagram taken along line I-I′ in FIG. 1;

FIG. 5 is a cross-sectional diagram taken along line II-II′ in FIG. 1;

FIG. 6 is a plan diagram illustrating a coil component according to a second embodiment of the present disclosure, corresponding to FIG. 2;

FIG. 7 is a L-T cross-sectional diagram illustrating a coil component according to a third embodiment of the present disclosure, corresponding to FIG. 4;

FIG. 8 is a W-T cross-sectional diagram illustrating a coil component according to a third embodiment of the present disclosure, corresponding to FIG. 5;

FIG. 9 is a is a graph of SRF properties of a coil component according to a first embodiment of the present disclosure;

FIG. 10 is a plan diagram illustrating a coil component according to a first comparative example not including a first connection portion, corresponding to FIG. 2;

FIG. 11 is a graph of SRF properties of a coil component according to a first comparative example;

FIG. 12 is a plan diagram illustrating a coil component according to a second comparative example not including a first connection portion, corresponding to FIG. 10; and

FIG. 13 is a graph of SRF properties of a coil component according to a second comparative example.

### DETAILED DESCRIPTION

Hereinafter, embodiments of the present disclosure will be described as follows with reference to the attached drawings.

The present disclosure may, however, be exemplified in many different forms and should not be construed as being limited to the specific embodiments set forth herein. An expression used in the singular encompasses the expression of the plural, unless it has a clearly different meaning in the context. The terms, “include,” “comprise,” “is configured to,” or the like of the description are used to indicate the presence of features, numbers, steps, operations, elements, portions or combination thereof, and do not exclude the possibilities of combination or addition of one or more features, numbers, steps, operations, elements, portions or combination thereof. Also, the expression that an element is disposed “On” may indicate that the element may be disposed above or below a target portion, and does not necessarily indicate the element is disposed above the target portion in the direction of gravity.

It will be understood that when an element is “coupled with/to” or “connected with” another element, the element may be directly coupled with/to another element, and there may be an intervening element between the element and another element. To the contrary, it will be understood that when an element is “directly coupled with/to” or “directly connected to” another element, there is no intervening element between the element and another element.

For example, structures, shapes, and sizes described as examples in embodiments in the present disclosure may be implemented in another exemplary embodiment without departing from the spirit and scope of the present disclosure.

In the drawings, the L direction may be defined as a first direction or a length direction, the W direction may be defined as a second direction or a width direction, and the W direction may be defined as a third direction or a thickness direction.

In the drawings, same elements will be indicated by same reference numerals. Also, redundant descriptions and detailed descriptions of known functions and elements that may unnecessarily make the gist of the present disclosure obscure will not be provided.

Various types of electronic components are used in electronic devices, and various types of coil components may be appropriately used between these electronic components for the purpose of removing noise.

That is, in electronic devices, a coil component may be used as a power inductor, a HF inductor, a general bead, a GHz bead, a common mode filter, or the like.

### First Embodiment

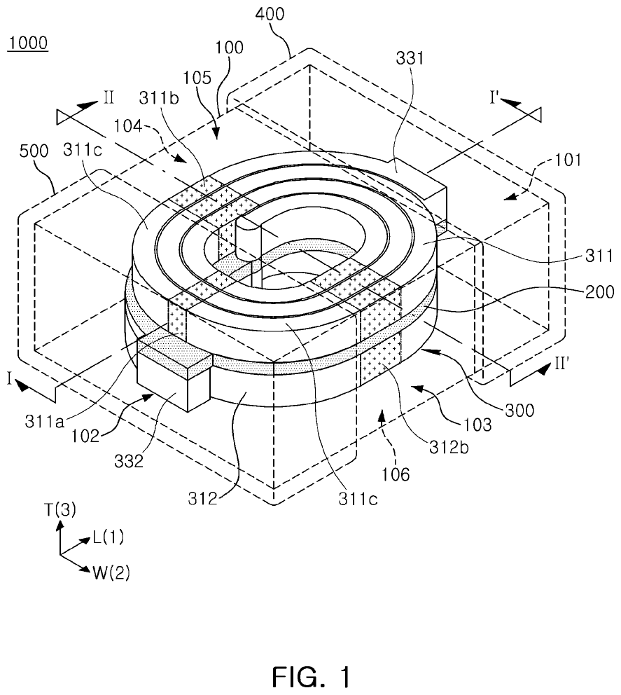

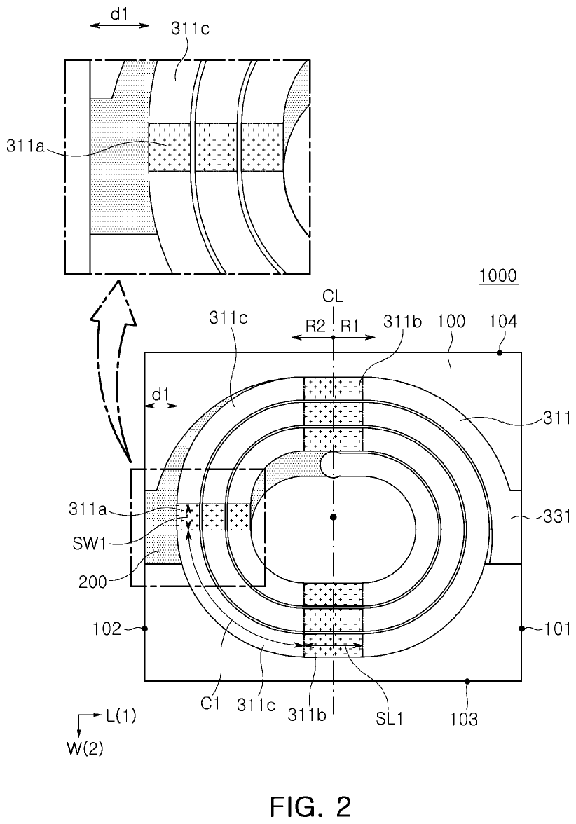

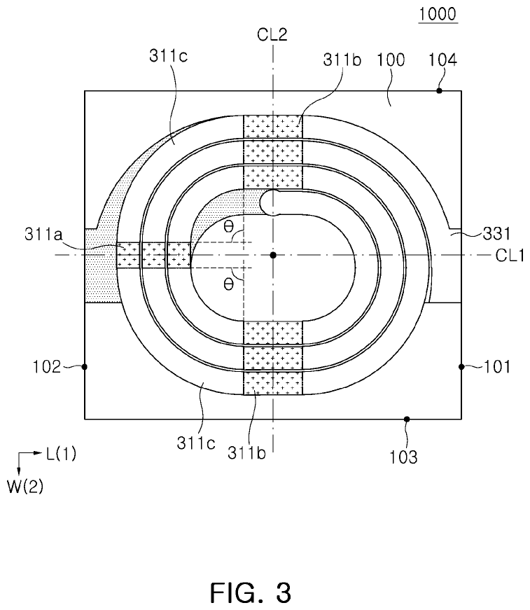

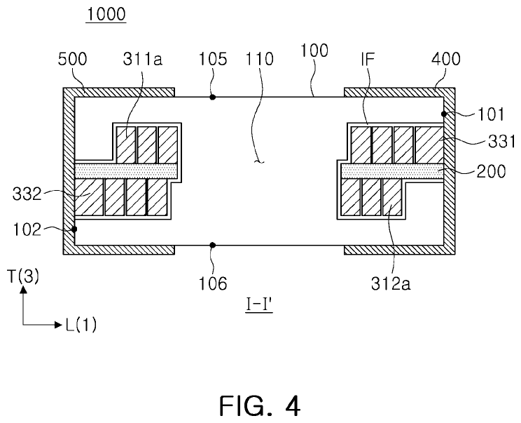

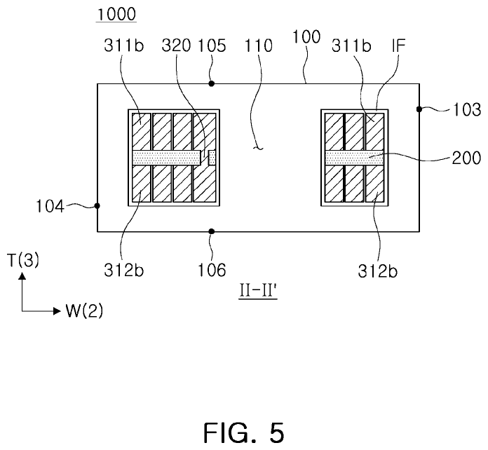

FIG. 1 is a perspective diagram illustrating a coil component according to a first embodiment. FIG. 2 is a plan diagram and an enlarged diagram in FIG. 1. FIG. 3 is a diagram illustrating an internal angle and a quadrant region between an extended line of a boundary between a corner portion and a first connection portion and an extended line of a boundary between a corner portion and a second connection portion in a plan diagram in FIG. 1. FIG. 4 is a cross-sectional diagram taken along line I-I′ in FIG. 1. FIG. 5 is a cross-sectional diagram taken along line II-II′ in FIG. 1.

To more clearly show coupling between components, an insulating layer on the body 100 applicable to the embodiment is not illustrated. Also, in FIGS. 2 and 3, external electrodes 400 and 500 are not illustrated.

Referring to FIGS. 1 to 5, the coil component 1000 according to the first embodiment may include a body 100, a support member 200, a coil 300, and external electrodes 400 and 500.

The coil component 1000 according to the embodiment may include first connection portions 311a and 312a having a linear shape in a region of the coil patterns 311 and 312, disposed opposite to the lead-out portions 331 and 332.

The first connection portions 311a and 312a may connect the plurality of corner portions 311c and 312c having a quadrant arc shape to each other, may be disposed in the second direction W, and may be spaced apart from the adjacent body surfaces 101 and 102 at a constant distance d1.

As the coil component according to the embodiment may include the first connection portions 311a and 312a having a linear shape in the coil patterns 311 and 312, and when these portions have a curved shape, a spacing distance d1 between the external electrodes 400 and 500 disposed on the body 100 may be widened, and accordingly, parasitic capacitance Cp between the coil patterns 311 and 312 and the external electrodes 400 and 500 may be reduced and self-resonant frequency (SRF) may increase.

Also, since the coil component according to the embodiment may include the first connection portions 311a and 312a having a linear shape in the coil patterns 311 and 312, when these portions have a curved shape, reduction in the area of core 110 disposed in a center of the coil patterns 311 and 312 may be reduced, and accordingly, degradation of saturation current (Isat) properties may be prevented.

In the description below, main components included in the coil component 1000 according to the embodiment will be described in greater detail.

The body 100 may form an exterior of the coil component 1000 in the embodiment, and the coil 300 and the support member 200 may be embedded therein.

The body 100 may have a hexahedral shape.

The body 100 may include a first surface 101 and a second surface 102 opposing each other in the length direction (L, the first direction), a third surface 103 and a fourth surface 104 opposing each other in the thickness direction (T, the second direction), and a fifth surface 105 and a sixth surface 106 opposing each other in the width direction (W, the third direction). Each of the first to fourth surfaces 101, 102, 103 and 104 of the body 100 may be a wall surface of the body 100 connecting the first surface 101 and the second surface 102 of the body 100.

The body 100 may be formed such that the coil component in which the external electrodes 400 and 500 are formed may have a length of 2.5 mm, a width of 2.0 mm and a thickness of 0.8 mm, may have a length of 2.0 mm, a width of 1.2 mm and a thickness of 1.0 mm, may have a length of 2.0 mm, a width of 1.2 mm and a thickness of 0.6 mm, may a length of 1.6 mm, a width of 0.8 mm and a thickness of 0.6 mm, may have a length of 1.6 mm, a width of 0.8 mm and a thickness of 0.4 mm, may have a length of 1.4 mm, a width of 1.2 mm and a thickness of 0.65 mm, may have a length of 1.0 mm, a width of 0.7 mm and a thickness of 0.65 mm, may have a length of 0.8 mm, a width of 0.4 mm and a thickness of 0.65 mm, or may have a length of 0.8 mm, a width of 0.4 mm and a thickness of 0.5 mm, but an embodiment thereof is not limited thereto. As the above-described exemplary dimensions for the length, width and thickness of coil component 1000 may refer to dimensions not reflecting process errors, dimensions in the range recognized as process errors may correspond to the above-described example dimensions.

The length of the above-described coil component 1000 may be a maximum value among dimensions of a plurality of line segments connecting two outermost boundary lines of the coil component 1000, opposing each other in the length direction L, to each other and in parallel to the length direction L, with respect to an optical microscope image or a scanning electron microscope (SEM) image with respect to a cross-section in the length direction L-thickness direction T taken from the central portion of the coil component 1000 taken in the width direction W. Alternatively, the length of the coil component 1000 may refer to a minimum value among the dimensions of the plurality of line segments described above. Alternatively, the length of the coil component 1000 may refer to an arithmetic mean value of at least three or more of the dimensions of the plurality of line segments described above. Here, the plurality of line segments parallel to the length direction L may be spaced apart from each other by an equal distance in the thickness direction T, but an embodiment thereof is not limited thereto.

The thickness of the above-described coil component 1000 be a maximum value among dimensions of a plurality of line segments connecting two outermost boundary lines of the coil component 1000, opposing each other in the thickness direction T, to each other and in parallel to the thickness direction T, with respect to an optical microscope image or a scanning electron microscope (SEM) image with respect to a cross-section in the length direction L-thickness direction T taken from the central portion of the coil component 1000 taken in the width direction W. Alternatively, the thickness of the coil component 1000 may refer to a minimum value among the dimensions of the plurality of line segments described above. Alternatively, the thickness of the coil component 1000 may refer to an arithmetic mean value of at least three or more of the dimensions of the plurality of line segments described above. Here, the plurality of line segments parallel to the thickness direction T may be spaced apart from each other by an equal distance in the length direction L, but an embodiment thereof is not limited thereto.

The width of the above-described coil component 1000 may be a maximum value among dimensions of a plurality of line segments connecting two outermost boundary lines of the coil component 1000, opposing each other in the width direction W, to each other and in parallel to the width direction W, with respect to an optical microscope image or a scanning electron microscope (SEM) image with respect to a cross-section in the length direction L-width direction W taken from the central portion of the coil component 1000 taken in the thickness direction T. Alternatively, the width of the coil component 1000 may refer to a minimum value among the dimensions of the plurality of line segments described above. Alternatively, the width of the coil component 1000 may refer to an arithmetic mean value of at least three or more of the dimensions of the plurality of line segments described above. Here, the plurality of line segments parallel to the width direction W may be spaced apart from each other by an equal distance in the length direction L, but an embodiment thereof is not limited thereto.

Alternatively, each of the length, a width and thickness of the coil component 1000 may be measured by a micrometer measurement method. The micrometer measurement method may be of determining a zero point with a gage repeatability and reproducibility (R&R) micrometer, inserting the coil component 1000 in the embodiment between tips of the micrometer, and measuring by turning a measuring lever of a micrometer. In measuring the length of the coil component 1000 by the micrometer measurement method, the length of the coil component 1000 may refer to a value measured once or may refer to an arithmetic average of values measured a plurality of times, which may be equally applied to the width and thickness of the coil component 1000.

The body 100 may include a magnetic material and resin. Specifically, the body 100 may be formed by laminating one or more magnetic composite sheets in which a magnetic material is dispersed in an insulating resin. The body 100 may have a structure other than a structure in which a magnetic material is dispersed in resin. For example, the body 100 may be formed of a magnetic material such as ferrite.

The magnetic material may be ferrite or metallic magnetic powder.

A ferrite powder may be at least one of, for example, spinel-type ferrite such as Mg—Zn-based ferrite, Mn—Zn-based ferrite, Mn—Mg-based ferrite, Cu—Zn-based ferrite, Mg—Mn—Sr-based ferrite, Ni—Zn-based ferrite, hexagonal ferrites such as Ba—Zn-based ferrite, Ba—Mg-based ferrite, Ba—Ni-based ferrite, Ba—Co-based ferrite, Ba—Ni—Co-based ferrite, garnet-type ferrites such as Y-based ferrite, and Li-based ferrites.

Metal magnetic powder may include one or more selected from a group consisting of iron (Fe), silicon (Si), chromium (Cr), cobalt (Co), molybdenum (Mo), aluminum (Al), niobium (Nb), copper (Cu) and nickel (Ni). For example, the magnetic metal powder may be at least one of pure iron powder, Fe—Si alloy powder, Fe—Si—Al alloy powder, Fe—Ni alloy powder, Fe—Ni—Mo alloy powder, Fe—Ni—Mo—Cu alloy powder, Fe—Co alloy powder, Fe—Ni—Co alloy powder, Fe—Cr alloy powder, Fe—Cr—Si alloy powder, Fe—Si—Cu—Nb alloy powder, Fe—Ni—Cr-based alloy powder and Fe—Cr—Al alloy powder.

The metal magnetic powder may be amorphous or crystalline. For example, the magnetic metal powder may be a Fe—Si—B—Cr amorphous alloy powder, but an embodiment thereof is not limited thereto.

Each particle of ferrite and magnetic metal powder may have an average diameter of about 0.1 μm to 30 μm, but an embodiment thereof is not limited thereto.

The body 100 may include two or more types of magnetic materials dispersed in a resin. Here, the different types of magnetic materials may indicate that the magnetic materials dispersed in the resin may be distinguished from each other by one of an average diameter, composition, crystallinity, and shape.

The resin may include epoxy, polyimide, a liquid crystal polymer, or the like, alone or in combination but an embodiment thereof is not limited thereto.

The body 100 may include a core 110 penetrating through the support member 200 and the coil 300. The core 110 may be formed by filling the through hole in the support member 200 and the coil 300 with a magnetic composite sheet, but an embodiment thereof is not limited thereto.

The support member 200 may be disposed in the body 100. The support member 200 may be a component supporting the coil 300. The support member 200 may be excluded in embodiments, such as when the coil 300 corresponds to a wound coil or has a coreless structure.

The support member 200 may be formed of a thermosetting insulating resin such as an epoxy resin, a thermoplastic insulating resin such as polyimide, or an insulating material including a photosensitive insulating resin, or an insulating material in which the insulating resin is impregnated with a reinforcing material such as glass fiber or inorganic filler. For example, the support member 200 may be formed of an insulating material such as prepreg, Ajinomoto build-up film (ABF), FR-4, bismaleimide triazine (BT) film, and photo imaginable dielectric (PID) film, but an embodiment thereof is not limited thereto.

As inorganic fillers, at least one selected from a group consisting of silica (SiO₂), alumina (Al₂O₃), silicon carbide (SiC), barium sulfate (BaSO₄), talc, mud, mica powder, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃) and calcium zirconate (CaZrO₃) may be used.

When the support member 200 is formed of an insulating material including a reinforcing material, the support member 200 may provide improved rigidity. When the support member 200 is formed of an insulating material not including glass fibers, a thickness of a component may be easily reduced by reducing an overall thickness of the support member 200 and the coil 300 (indicating a sum of dimensions of the coil 300 and the support member 200 in the first direction T in FIG. 1). When the support member 200 is formed of an insulating material including a photosensitive insulating resin, the number of processes for forming the coil 300 may be reduced, which may be advantageous in reducing production costs, and a fine via 320 may be formed. The thickness of the support member 200 may be, for example, 10 μm or more and 50 μm or less, but an embodiment thereof is not limited thereto.

The coil 300 may be disposed on the support member 200. The coil 300 may be buried in body 100 and may exhibit properties of a coil component. For example, when coil component 1000 in the embodiment is used as a power inductor, the coil 300 may store an electric field as a magnetic field and maintain an output voltage, thereby stabilizing power supply of an electronic device.

The coil 300 may be formed on at least one of both surfaces of the support member 200 opposing each other, and may form at least one turn. In an embodiment, the coil 300 may include coil patterns 311, 312, via 320, and lead-out portions 331 and 332.

Referring to FIGS. 1 to 5, each of the first coil pattern 311 and the second coil pattern 312 may be disposed on both surfaces of the support member 200 opposing each other, and may be in the form of a planar spiral forming at least one turn around the core 110 of the body 100. For example, with respect to the direction in FIG. 1, the first coil pattern 311 may be disposed on an upper surface of the support member 200 and may form at least one turn around the core 110. The second coil pattern 312 may be disposed on a lower surface of the support member 200 and may form at least one turn around the core 110. The first and second coil patterns 311 and 312 may be formed such that ends of outermost turns connected to the lead-out portions 331 and 332 may extend in directions of the first surface 101 and the second surface 102 of the body 100, respectively.

Referring to FIG. 2, on the L-W cross-section perpendicular to a winding axis of the coil patterns 311 and 312, the coil patterns 311 and 312 may be divided into a first region R1 in which the lead-out portions 331 and 332 are disposed, and a second region R2 in which the lead-out portions 331 and 332 are not disposed with respect to a central line CL perpendicular to the first direction L and passing through centers of coil patterns 311 and 312.

Hereinafter, the embodiment will be described with respect to the first coil pattern 311 and the second external electrode 500, and the second coil pattern 312 and the first external electrode 400 may also be described.

When describing with respect to the first coil pattern 311 in FIG. 2, an outermost turn of a portion corresponding to the second region R2 of the first coil pattern 311 may include a plurality of corner portions 311c having a quadrant arc shape, and a first connection portion 311a having a linear shape connecting the plurality of corner portions 311c to each other.

Referring to FIGS. 1 and 2, the first connection portion 311a may be disposed along the second direction W, and may be disposed parallel to the second surface 102 of the body 100, which is adjacent to the first connection portion 311a.

Here, since the second surface 102 of the body 100 corresponds to the surface on which the second external electrode 500 is disposed, the first coil pattern 311 may include the first connection portion 311a having a linear shape such that a distance d1 from the second external electrode 500 may be ensured.

Referring to FIGS. 1 to 3, an outermost turn of a portion corresponding to the second region R2 of the first coil pattern 311 may be disposed in the first direction L, and may further include a second connection portion 311b parallel to the third surface 103 or the fourth surface 104 of the body 100.

The first connection portion 311a and/or the second connection portion 311b may have a linear shape having a curvature of 0.

Also, the first connection portion 311a and/or the second connection portion 311b may include an internal side surface opposing a center of the first coil pattern 311, and an external side surface opposing the internal side surface, and a curvature of each of the internal side surface and the external side surface may be formed as 0.

Here, the curvature of 0 is not limited to an exact linear shape, and may indicate that a curvature close to 0 may be formed, including process errors, positional deviations, and measurement errors occurring during a manufacturing process.

The second connection portion 311b may have a linear shape having a curvature of 0. Here, the curvature of 0 is not limited to an exact linear shape, and may indicate that a curvature close to 0 may be formed, including process errors, positional deviations, and measurement errors occurring during a manufacturing process.

Referring to FIG. 3, the angle (θ) formed by a conceptual line extending a boundary between the first connection portion 311a and the corner portion 311c and a conceptual line extending a boundary between the second connection portion 311b and the corner portion 311c is at least 80 degrees and no more than 100 degrees.

Here, the conceptual line formed by extending the boundary between the first connection portion 311a and the corner portion 311c and the conceptual line formed by extending the boundary between the second connection portion 311b and the corner portion 311c may ideally form a right angle, but an error of ±10 degrees may be allowed considering process errors, positional deviations, and measurement errors occur during the manufacturing process.

Referring to FIGS. 1 to 3, the corner portion 311c may be a component connecting the first connection portion 311a to the second connection portion 311b. That is, one end of the corner portion 311c may be connected to the first connection portion 311a, and the other end of the corner portion 311c may be connected to the second connection portion 311b.

The corner portion 311c may have a curved shape having a curvature greater than 0, and may form a turn less than ¼ turn.

Also, the corner portion 311c may include an internal side surface opposing a center of the first coil pattern 311, and an external side surface opposing an internal side surface, and a curvature of at least one of the internal side surface and the external side surface may be greater than 0.

Referring to FIG. 3, a cross-section perpendicular to a winding axis of the first coil pattern 311 may be divided into quadrant regions formed by a first axis CL1 parallel to the first direction L and passing through a center of body 100, and the second axis CL2 parallel to the second direction W and passing through a center of body 100, and the corner portion 311c may be disposed in one of the quadrant regions.

Also, the first connection portion 311a may be disposed to pass through the first axis CL1, and the second connection portion 311b may be disposed to pass through the second axis CL2.

For ease of description, in FIGS. 1 to 3, a conceptual boundary line may be indicated and hatched differently between the first connection portion 311a, the corner portion 311c, and the second connection portion 311b, and the first connection portion 311a, the corner portion 311c, and the second connection portion 311b may correspond to each region of an integrated first coil pattern 311.

Also, a boundary between the first connection portion 311a, the corner portion 311c, and the second connection portion 311b may be defined as a conceptual line connecting points at which curvature changes on each of the internal side surface and the external side surface.

Also, characteristics of the first connection portion 311a, the corner portion 311c, and the second connection portion 311b have been described with respect to the outermost turn of the first coil pattern 311, but an example embodiment thereof is not limited thereto, and as illustrated in FIGS. 1 to 3, the plurality of turns of coil patterns 311 and 312 may include the first connection portions 311a and 312a, the corner portions 311c and 312c, and the second connection portions 311b and 312b, respectively.

Referring to FIG. 2, a length SW1 of the first connection portion 311a may be shorter than a length C1 of each corner portion 311c.

As the first connection portion 311a having a linear shape is formed shorter than the corner portion 311c having a curved shape, as compared to the case in which the first connection portion 311a having linear shape is longer than the corner portion 311c having the curved shape, when current flows through the first coil pattern 311, magnetic flux may be prevented from concentrating around the corner portion 311c.

Here, the length SW1 of the first connection portion 311a may refer to, with respect to an optical microscope image or a scanning electron microscope (SEM) image of the length direction L-width direction W cross-section taken from a central portion of the first coil pattern 311 of the coil component 1000 in the thickness direction T, an arithmetic mean value of at least three of dimensions of the plurality of line segments spaced apart from each other by connecting both end boundaries of the first connection portion 311a in the outermost turn of the first coil pattern 311 appearing on the above image in the width direction W.

Also, the length C1 of the corner portion 311c may refer to, with respect to an optical microscope image or a scanning electron microscope (SEM) image of the length direction L-width direction W cross-section taken from a central portion of the first coil pattern 311 of the coil component 1000 in the thickness direction T, a dimension value of the line connected along a center of a line width calculated using the Image J program tool between both ends boundaries of the corner portion 311c on the outermost turn of the first coil pattern 311 appearing on the image above, but an example embodiment thereof is not limited thereto.

Referring to FIGS. 1 to 4, the lead-out portions 331 and 332 may extend from the coil patterns 311 and 312 to the first surface 101 or the second surface 102 of the body 100. Specifically, the first lead-out portion 331 may be connected to an outer end of the first coil pattern 311, may extend to the first surface 101 of the body 100, and may be connected to the first external electrode 400. Also, the second lead-out portion 332 may be connected to the outer end of the second coil pattern 312, may extend to the second surface 102 of the body 100 and may be connected to the second external electrode 500.

Referring to FIG. 5, the coil 300 may further include a via 320 connecting the first coil pattern 311 to the second coil pattern 312. Specifically, the via 320 may connect inner ends of innermost turns of the first and second coil patterns 311 and 312 to each other through the support member 200. Accordingly, a signal input to the first external electrode 410 may be output to the second external electrode 420 through the first lead-out portion 331, the first coil pattern 311, the via 320, the second coil pattern 312, and the second lead-out portion 332. Through this structure, each component of coil 300 may function as a single coil connected between the first and second external electrodes 400 and 500.

At least one of the coil patterns 311, 312, the via 320, and the lead-out portions 331 and 332 may include at least one conductive layer.

As an example, when forming the first coil pattern 311, the via 320, and the first lead-out portion 331 by plating on an upper surface of the support member 200 (with respect to the direction in FIG. 1), each of the first coil pattern 311, the via 320, and the first lead-out portion 331 may include a seed layer and an electroplating layer. The seed layer may be formed by electroless plating or vapor deposition methods such as sputtering. Each of the seed layer and the electroplating layer may have a single-layer structure or a multilayer structure. An electroplating layer having a multi-layer structure may be formed as a conformal film structure in which one electroplating layer is covered by another electroplating layer, or may be formed in a shape in which another electroplating layer is laminated to only one surface of one electroplating layer. The seed layer of the first coil pattern 311, the seed layer of the via 320, and the seed layer of the first lead-out portion 331 may be formed integrally, and boundaries may not be formed therebetween, but an embodiment thereof is not limited thereto. The electroplating layer of the first coil pattern 311, the electroplating layer of via 320, and the electroplating layer of first lead-out portion 331 may be formed integrally, and boundaries may not be formed therebetween, but an embodiment thereof is not limited thereto.

Each of the coil patterns 311, 312, the via 320, and the lead-out portions 331 and 332 may include a conductive material such as copper (Cu), aluminum (Al), silver (Ag), tin (Sn), gold (Au), nickel (Ni), lead (Pb), titanium (Ti), chromium (Cr), molybdenum (Mo) or alloys thereof, but is not limited thereto.

The external electrodes 400 and 500 may be disposed on the first surface 101 and the second surface 102 of the body 100 and may be connected to the first and second lead-out portions 331 and 332, respectively. Specifically, the first external electrode 400 may be disposed on the first surface 101 of the body 100 and may be in contact with and connected to the first lead-out portion 331. Also, the second external electrode 500 may be disposed on the second surface 102 of the body 100 and may be in contact with and connected to the second lead-out portion 332.

The external electrodes 400 and 500 may electrically connect the coil component 1000 to the printed circuit board when the coil component 1000 according to the embodiment is mounted on a printed circuit board. For example, the external electrodes 400 and 500 spaced apart from each other on the first surface 101 and the second surface 102 of the body 100 and the connection portion of the printed circuit board may be electrically connected to each other.

The external electrodes 400 and 500 may be formed by a conductive material such as copper (Cu), aluminum (Al), silver (Ag), tin (Sn), gold (Au), nickel (Ni), lead (Pb), chromium (Cr), titanium (Ti), or alloys thereof, but an example embodiment thereof is not limited thereto.

A plurality of external electrodes 400 and a plurality of external electrodes 500 may be formed. As an example, the first external electrode 400 may include a first layer in contact with the first lead-out portion 331 and a second layer disposed on the first layer. Here, the first layer may be a conductive resin layer including conductive powder including at least one of copper (Cu) and silver (Ag) and an insulating resin, or may be a copper (Cu) plating layer. The second layer may have a double-layer structure of nickel (Ni) plating layer/tin (Sn) plating layer.

Referring to FIGS. 4 and 5, an insulating film IF may be disposed between the coil 300 and the body 100 to cover the coil 300. The insulating film IF may be formed along a surface of the support member 200 and the coil 300. The insulating film IF may be provided to insulate the coil 300 from the body 100, and may include known insulating materials such as paralene, but an example embodiment thereof is not limited thereto. The insulating film IF may be formed by a method such as vapor deposition, but an example embodiment thereof is not limited thereto, and the insulating film IF may be formed by laminating an insulating film on both surfaces of the support member 200.

The coil component 1000 according to the embodiment may further include an insulating layer disposed on the third to sixth surfaces 103, 104, 105, and 106 of the body 100 in a region other than the region in which the external electrodes 400 and 500 are disposed.

For example, the insulating layer may be formed by applying and curing an insulating material including an insulating resin to the surface of the body 100. The insulating layer may further include at least one of thermoplastic resins such as polystyrene resin, vinyl acetate resin, polyester resin, polyethylene resin, polypropylene resin, polyamide resin, rubber resin, and acrylic resin, thermosetting resins such as phenolic resin, epoxy resin, urethane resin, melamine resin, alkyd resin, or the like, and photosensitive resin.

### Second Embodiment

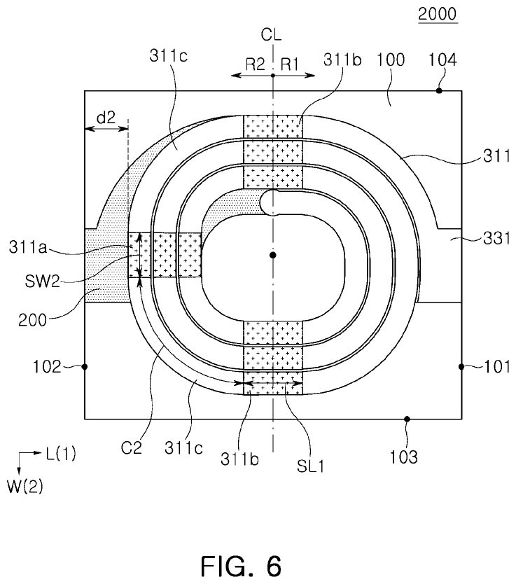

FIG. 6 is a plan diagram illustrating a coil component according to a second embodiment, corresponding to FIG. 2.

Comparing FIG. 6 with FIG. 2, a length SW2 of the first connection portion 311a of the coil component 2000 according to the embodiment, a length C2 of the corner portion 311c, and a spacing distance between the second surface 102 of the body 100 and the first connection portion 311a d2 may be different from the first embodiment.

Accordingly, in describing the embodiment, only the length SW2 of the first connection portion 311a, the length C2 of the corner portion 311c, and the spacing distance d2 between the second surface 102 of the body 100 and the first connection portion 311a will be described, which are different from the first embodiment. The description in the first embodiment may be applied for the other components.

Referring to FIG. 6, the length SW2 of the first connection portion 311a of the coil component 2000 according to the embodiment may be formed to be longer than the length SW1 of the first connection portion 311a of the first embodiment.

Also, the length C2 of the corner portion 311c of the coil component 2000 according to the embodiment may be shorter than the length C1 of the corner portion 311c of the first embodiment.

However, Similarly to the first embodiment, the length SW2 of the first connection portion 311a may be shorter than the length C2 of the corner portion 311c.

In the coil component 2000 according to the embodiment, as compared to the first embodiment, a distance d2 between the second surface 102 of the body 100 in which the second external electrode 500 is disposed and the coil pattern 311 may increases, such that the effect of reducing parasitic capacitance Cp and increasing self-resonant frequency (SRF) may improve.

Also, the length SW2 of the first connection portion 311a of the linear shape may increase, the length C2 of the corner portion 311c may decrease, and the length SL1 of the second connection portion 311b may be maintained, such that a decrease in central core area caused by the increase in the spacing distance d2 between the second surface 102 of the body 100 and the first coil pattern 311 may be offset.

Accordingly, the coil component 2000 according to the embodiment may maintain saturation current (Isat) properties while increasing self-resonant frequency (SRF).

### Third Embodiment

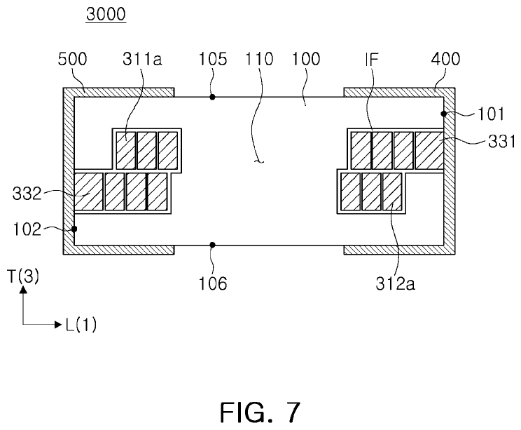

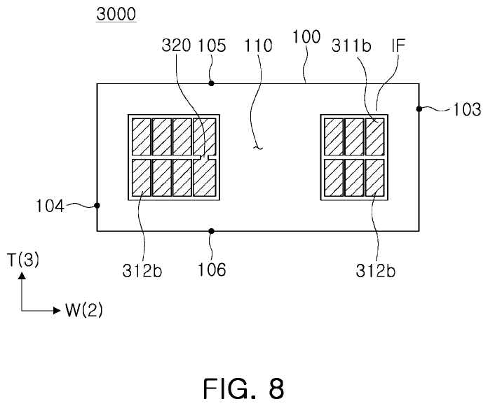

FIG. 7 is a L-T cross-sectional diagram illustrating a coil component according to a third embodiment of the present disclosure, corresponding to FIG. 4. FIG. 8 is a W-T cross-sectional diagram illustrating a coil component according to a third embodiment of the present disclosure, corresponding to FIG. 5.

Comparing FIGS. 7 and 8 with FIGS. 4 and 5, whether the support member 200 is disposed between the first coil pattern 311 and the second coil pattern 312, and the distance between the first coil pattern 311 and the second coil pattern 312 may be different.

Accordingly, in third the embodiment, the support member 200 is not disposed between the first coil pattern 311 and the second coil pattern 312, which is different from the first embodiment, and the distance between the first coil pattern 311 and the second coil pattern 312 will be described. The description in the first embodiment may be applied for the other components.

Referring to FIGS. 7 and 8, the coil 300 may be integrally covered and supported by the insulating film IF. The embodiment may correspond to a coreless structure in which the support member 200 is not provided, and may be implemented by disposing the coil 300 on the support member 200, completely removing the support member 200, and forming the insulating film IF.

Referring to FIG. 8, the first coil pattern 311 and the second coil pattern 312 may be connected to each other by a via 320 penetrating the insulating film IF.

In the embodiment, the insulating film IF may include parylene or polyimide, and may be formed by a method such as vapor deposition or film lamination, but an example embodiment thereof is not limited thereto.

Since the insulating film IF may be formed to have a thickness smaller than that of the support member 200, in the coil component 3000 according to the embodiment, a distance between the first coil pattern 311 and the second coil pattern 312 may decrease by a space occupied by the support member 200 as compared to the first embodiment, and accordingly, a space for charging a magnetic material may be ensured in the body 100 of a limited size, such that the effective volume may increase.

Accordingly, inductance properties of the coil component 300 according to the embodiment may be improved as the effective volume increases.

### Comparison of SRF Improvement Effect

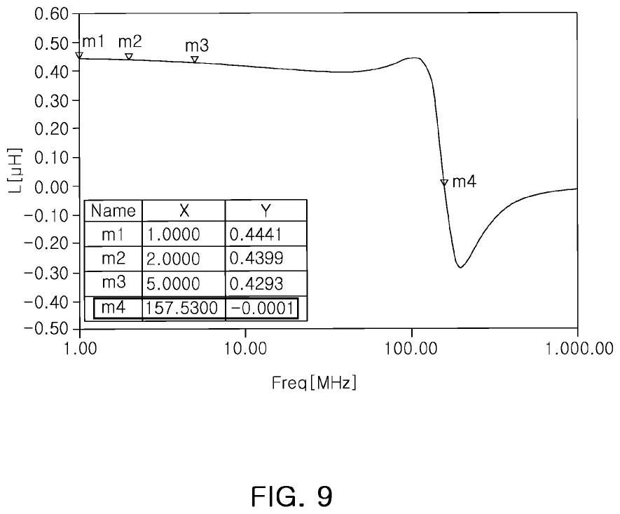

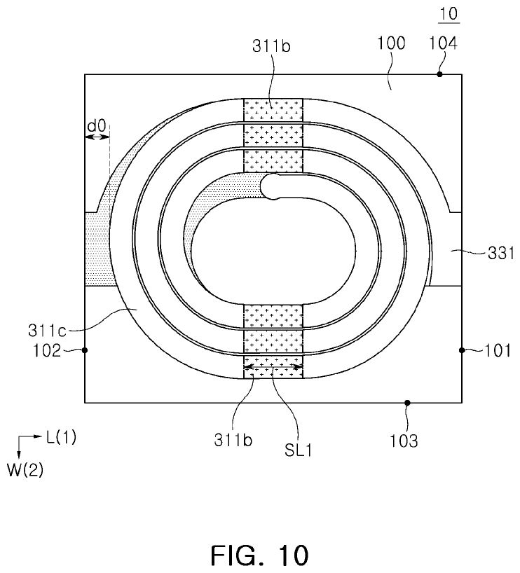

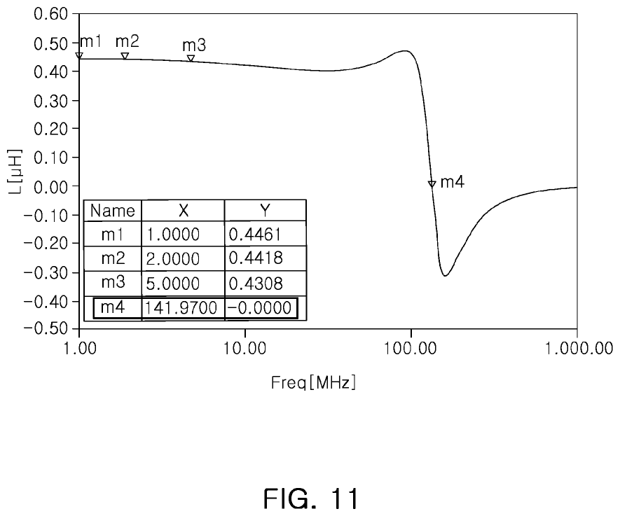

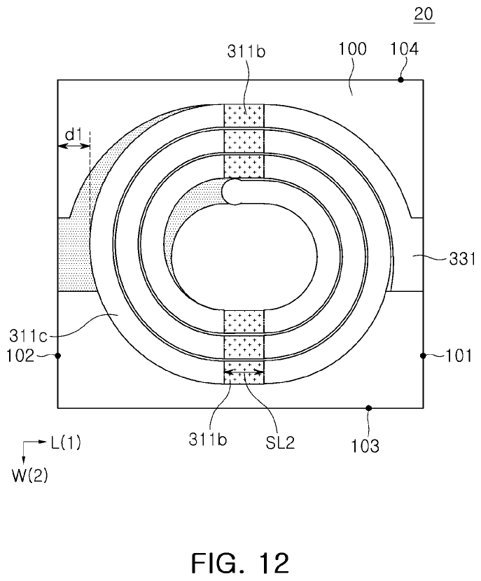

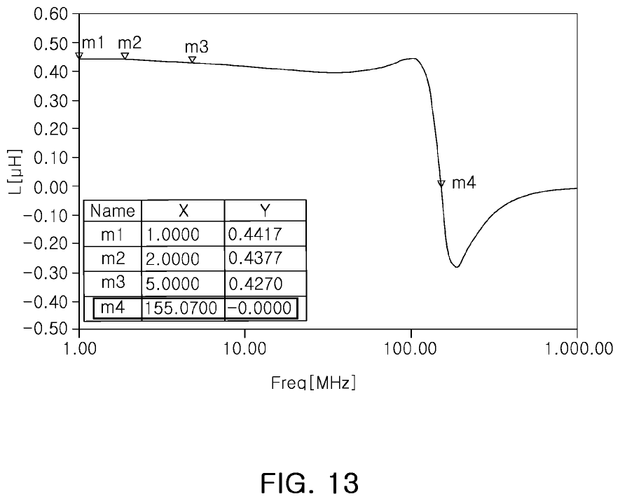

FIG. 9 is a is a graph of SRF properties of a coil component according to a first embodiment. FIG. 10 is a plan diagram illustrating a coil component according to a first comparative example not including a first connection portion, corresponding to FIG. 2. FIG. 11 is a graph of SRF properties of a coil component according to a first comparative example. FIG. 12 is a plan diagram illustrating a coil component according to a second comparative example not including a first connection portion, corresponding to FIG. 10. and FIG. 13 is a graph of SRF properties of a coil component according to a second comparative example.

FIG. 9 corresponds to a graph illustrating changes in inductance according to changes in frequency applied to the coil component 1000 according to the first embodiment, and the sample used in the experiment may be the coil component 1000 having a length of 1.4 mm, a width of 1.2 mm, and a thickness of 0.65 mm.

In the sample, the spacing distance d1 between the external electrode 500 and the first coil pattern 311 may be 120 μm, the spacing distance between the first coil pattern 311 and the third surface 103 of the body 100 may be 70 μm, and the area of the central core may be 0.3054 mm².

Referring to FIG. 9, when the frequency of coil component 1000 according to the first embodiment was 157.530 MHz, inductance was almost 0 and the SRF was measured as 157.530 MHz.

Referring to FIG. 10, the coil component 10 according to the first comparative example may not include the first connection portion 311a having a linear shape, differently from the coil component 1000 according to the first embodiment, and accordingly, the distance do between the first coil pattern 311 and the second surface 102 of the body 100 may be shorter than the first embodiment.

The sample used in the experiment was the coil component 10 having a length of 1.4 mm, a width of 1.2 mm, and a thickness of 0.65 mm, and the spacing distance d0 between the external electrode 500 and the first coil pattern 311 in the sample was 80 μm. The spacing distance between the first coil pattern 311 and the third surface 103 of the body 100 was 70 μm, and the area of the central core was 0.2961 mm².

Referring to FIG. 11, when the frequency of coil component 10 according to the first comparative example was 141.970 MHz, the inductance was 0 and the SRF was measured to be 141.970 MHz.

As illustrated in the above results, in the coil component 1000 according to the first embodiment, the distance d1 from the second surface 102 of the body 100 on which the second external electrode 500 is disposed was widened by the first connection portion 311a of the linear shape, such that parasitic capacitance decreased and the SRF increased by 10.96%.

Referring to FIG. 12, the coil component 20 according to the second comparative example may not include the first connection portion 311a having a linear shape when compared to coil component 1000 according to the first embodiment, but the distance d1 between the first coil pattern 311 and the second surface 102 of the body 100 may be formed the same as in the first embodiment.

The sample used in the experiment was the coil component 20 having a length of 1.4 mm, a width of 1.2 mm, and a thickness of 0.65 mm, and the spacing distance d1 between the external electrode 500 and the first coil pattern 311 in the sample was 120 μm, same as in the first embodiment, the spacing distance between the first coil pattern 311 and the third surface 103 of the body 100 was 70 μm, and the area of the central core was 0.2536 mm².

Here, as for the central core area, the coil component 20 according to the second comparative example also may not include the first connection portion 311a of linear shape, such that the distance d1 between the first coil pattern 311 and the second surface 102 of the body 100 was the same as in the coil component 1000 according to the first embodiment, the central core area was small.

A Isat value of the coil component 1000 according to the first embodiment was 4.0 A, whereas a Isat value of the coil component 20 according to the second comparative example was measured to be 3.7625 A, which is assumed to be a side effect due to the decrease in central core area.

Referring to FIG. 13, when the frequency of coil component 20 according to the second comparative example was 155.070 MHz, inductance was 0 and SRF was measured to be 155.070 MHz.

As illustrated in the above results, in the case of coil component 1000 according to the first embodiment, as compared to coil component 20 according to the second comparative example without the first connection portion 311a having a linear shape, the spacing distance d1 between the first coil pattern 311 and the second surface 102 of body 100 was similar, and SRF increased by 1.59%.

In particular, the area of the central core of coil component 1000 according to the first embodiment was increased by the first connection portion 311a of the linear shape, such that the saturation current (Isat) increased by 6.31% as compared to the coil component 20 according to the second comparative example.

To sum up, in the coil component 1000 according to the first embodiment, it was confirmed that the SRF properties were improved while the saturation current (Isat) properties were not deteriorated as compared to the first comparative example and the second comparative example.

According to the aforementioned embodiments, as the distance between the external electrode and the coil increases, the self-resonant frequency (SRF) of the coil component may increase.

According to another aspect, while the SRF is increased, the area of the coil's central core may be maintained or may be reduced to a minimum, and degradation of the saturation current (Isat) properties of the coil components may be reduced.

While the embodiments have been illustrated and described above, it will be apparent to those skilled in the art that modifications and variations could be made without departing from the scope of the present disclosure as defined by the appended claims.

What is claimed is:

1. A coil component, comprising:
a body including a first surface and a second surface opposing each other in a first direction, and a third surface and a fourth surface opposing each other in a second direction perpendicular to the first direction;
a coil disposed in the body and including a coil pattern having at least one turn and a lead-out portion extending from an outer end of the coil pattern to the first surface or the second surface; and
an external electrode disposed on the body and connected to the coil,
wherein the coil pattern is divided into a first region in which the lead-out portion is disposed, and a second region in which the lead-out portion is not disposed with respect to a central line perpendicular to the first direction and passing through a center of the coil pattern on a cross-section perpendicular to a winding axis of the coil pattern, and
wherein an outermost turn of the second region includes at least two curved corner portions, and a linear first connection portion connecting adjacent corner portions to each other, and a length of the first connection portion is shorter than a length of each of the corner portions.

2. The coil component of claim 1, wherein the first connection portion is disposed in the second direction and is parallel to a surface of the body adjacent to the first connection portion.

3. The coil component of claim 1, wherein an outermost turn of the second region is disposed in the first direction and further includes a second connection portion parallel to the third surface or the fourth surface of the body.

4. The coil component of claim 3, wherein an angle formed by a conceptual line extending a boundary between the first connection portion and one of the at least two corner portions and a conceptual line extending a boundary between the second connection portion and one of the at least two corner portion is in a range from 80 degrees to 100 degrees.

5. The coil component of claim 3, wherein one of the at least two corner portion connects the first connection portion to the second connection portion.

6. The coil component of claim 3,
wherein a cross-section perpendicular to a winding axis of the coil pattern is divided into quadrant regions formed by a first axis parallel to the first direction and passing through a center of the body, and second axis parallel to the second direction and passing through the center of the body, and
wherein the corner portion is disposed in one of the quadrant regions.

7. The coil component of claim 6, wherein the first connection portion passes through the first axis.

8. The coil component of claim 6, wherein the second connection portion passes through the second axis.

9. The coil component of claim 1, wherein the first connection portion has a curvature of 0.

10. The coil component of claim 1, wherein the at least two corner portions have a curvature greater than 0.

11. The coil component of claim 3, wherein the second connection portion has a curvature of 0.

12. The coil component of claim 3, wherein each of the at least two corner portions form a turn less than ¼ turn.

13. The coil component of claim 1,
wherein the first connection portion includes an internal side surface facing the center of the coil pattern, and an external side surface opposing the internal side surface, and
wherein a curvature of each of the internal side surface and the external side surface is 0.

14. The coil component of claim 1,
wherein the corner portion includes an internal side surface facing the center of the coil pattern, and an external side surface opposing the internal side surface, and
wherein a curvature of at least one of the internal side surface and the external side surface is greater than 0.

15. The coil component of claim 3,
wherein the second connection portion includes an internal side surface facing the center of the coil pattern, and an external side surface opposing the internal side surface, and
wherein a curvature of each of the internal side surface and the external side surface is 0.

16. The coil component of claim 3, wherein the coil pattern has a plurality of turns, and each turn includes the first connection portion.

17. The coil component of claim 1, further comprising:
a support member disposed in the body,
wherein the coil is disposed on the support member.

18. The coil component of claim 17,
wherein the support member includes a first surface and a second surface opposing each other, and
wherein the coil includes a first coil pattern disposed on the first surface of the support member, a first lead-out portion extending from the first coil pattern to the first surface, a second coil pattern disposed on the second surface of the support member, a second lead-out portion extending from the second coil pattern to the second surface, and a via connecting the first coil pattern to an inner end of the second coil pattern.

19. The coil component of claim 18, wherein each of the first coil pattern and the second coil pattern includes the at least two corner portions and the first connection portion.

20. A coil component, comprising:
a coil including a coil pattern having at least one turn and lead-out portions extending from outer ends of the coil pattern, the coil pattern being divided into a first region in which the lead-out portions are not disposed and a second region in which the lead-out portions are disposed, the second region including a first curved corner portion, a first linear connection portion and a second curved corner portion contiguous with each other, wherein a length of the first linear connection portion is shorter than the first and second curved corner portions;
a body embedding the coil;
external electrodes disposed on opposing end surfaces of the body,
wherein the first linear connection portion is disposed parallel to a side surface of the body closest thereto.

21. The coil component of claim 20, further comprising a second linear connection portion disposed parallel to one of the end surfaces, wherein the first linear connection portion, the second curved corner portion and the second linear connection portion are continuous with each other.

22. The coil component of claim 20, wherein when a cross-section perpendicular to a winding axis of the coil pattern is divided into quadrant regions formed by a first axis connecting the end surfaces and passing through a center of the body, and second axis connecting the side surfaces and passing through the center of the body, and
wherein one of the first and second corner portions is disposed in one of the quadrant regions.

23. The coil component of claim 20, further comprising a support member disposed in the body,
wherein coil is disposed on the support member, and
wherein the coil pattern comprises:
a first coil pattern having a first lead-out portion and disposed on a first surface of the support member, the first lead-out portion connecting to one of the external electrodes,
a second coil pattern having a second lead-out portion and disposed on a second surface of the support member opposing the first surface, the second lead-out portion connecting to another of the external electrodes,
wherein inner ends of the first and second coil patterns are connected by a via penetrating the support member.
